(19) United States
(12) Patent Application Publication
(10) Pub. No.: US 2007/0060428 A1
(43) Pub. Date: Mar. 15, 2007

(54) Toothed wheel of a bicycle drivetrain

(75) Inventor: Mario Meggiolan, Creazzo (Vicenza) (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: CAMPAGNOLO S.r.l., Vicenza (IT)

(21) Appl. No.: 11/517,713

(22) Filed: Sep. 8, 2006

(30) Foreign Application Priority Data
Sep. 15, 2005 (EP) EP 05425647.4

(51) Int. Cl. F16H 55/30; F16H 55/12; F16H 59/00

(52) U.S. Cl. 474/160; 474/78; 474/152

(57) ABSTRACT

A toothed wheel is described with a peripheral portion that comprises a side projection at one or more teeth, projecting with respect to one of the sides of the toothed wheel. The projection provides the necessary guide for the chain and the stability of the coupling between chain and toothed wheel, without making heavier the toothed wheel itself with an excessive thickness in all of its parts. Such a wheel also allows the lack of material in the vicinity of the projection to be exploited to make the gearshifting operations in a group of many toothed wheels easier. A pair of toothed wheels is also described wherein the wheel of greater diameter comprises a first specialized tooth for upward gearshifting, in which wheel the outer side of the peripheral portion comprises a substantially flat area without recesses, situated in front with respect to the specialized tooth and outside the teeth.

### FIELD OF INVENTION

The present invention refers to a toothed wheel of a bicycle drivetrain. By the term toothed wheel here and hereafter both a crown of a crankset of a front gearshift group, and a sprocket of a rear gearshift group are meant; the crowns are normally two or three in number, whereas the sprockets are normally from five to ten in number. Hereafter, reference shall be made in particular to a sprocket, but what has been described and illustrated must equally be considered valid for a crown.

### BACKGROUND

A toothed wheel of a bicycle drivetrain normally is flat shaped, defined between two opposite sides; hereafter, the side facing towards another toothed wheel of smaller diameter shall be called the outer side, whereas the face facing towards a toothed wheel of greater diameter shall be called the inner side. It should be noted that a sprocket assembly is normally mounted with the toothed wheels of smaller diameter towards the outside of the bicycle wheel and therefore the outer side of the sprocket as defined above is actually the side that faces towards the outside of the bicycle wheel; vice-versa, a crankset is normally mounted with the toothed wheels of greater diameter towards the outside of the bottom bracket and therefore the inner side of the crown is normally the side that faces towards the outside of the bottom bracket.

In the toothed wheel it is possible to define a central portion surrounded by a peripheral portion; the central portion comprises the means for anchoring the toothed wheel in its operating position in the sprocket assembly or in the crankset, whereas the peripheral portion comprises a plurality of teeth intended to engage with a chain of the bicycle drivetrain.

During riding, the chain is moved from one crown to another or from one sprocket to another according to the cyclist's needs. For such a purpose, the bicycle is provided with a front gearshift group associated with the crankset and a rear gearshift group associated with the sprocket assembly. In both cases, the gearshift group comprises a derailleur that engages the transmission chain moving it on toothed wheels of different diameter and having a different number of teeth, so as to obtain different transmission ratios. The derailleur, be it that of the rear gearshift group or that of the front gearshift group, is moved in one direction by the traction action exerted by an inextensible cable that is normally sheathed (commonly known as Bowden cable), in the opposite direction by the elastic return action of a spring provided in the gearshift itself.

Normally, the direction in which the movement is determined by the return spring is that in which the chain passes from a toothed wheel of greater diameter to a toothed wheel of smaller diameter, i.e. that of so-called downward gearshifting; vice-versa, the traction action of the control cable takes place in the direction of so-called upward gearshifting, wherein the chain moves from a toothed wheel with a smaller diameter to a toothed wheel with a larger diameter. It should be noted that with reference to the crankset, downward gearshifting corresponds to a lower transmission ratio, whereas with reference to the sprocket assembly, it corresponds to the passage to a greater transmission ratio.

According to the prior art, to assist the movement of the chain between different toothed wheels (upward and downward gearshifting), the toothed wheels themselves are suitably shaped and have recesses on the sides and bevelings on the teeth. The recesses are normally depression zones made on the outer side through a reduction of its thickness in the direction of the middle plane of the toothed wheel itself. The bevelings on the teeth normally consist of localized reductions of the material and involve both the outer side and the inner side of the teeth, from the crest up to near to the bottom of the space defined between two crests of two adjacent teeth.

In known toothed wheels, the bevelings are made on a limited number of teeth of the total number present on the circumference of the toothed wheel and partially involve the tooth along its width, with width being understood to be the circumferential extension of the tooth. This allows almost all of the teeth to be of a sufficient thickness to determine guide surfaces for the links of the chain sufficient to ensure an acceptable stability of the chain on the toothed wheel during pedaling. In particular, such a thickness allows the guiding of the portions of chain consisting of facing pairs of inner links. Such a thickness also coincides with the thickness of the peripheral portion and of the central portion of the toothed wheel.

As for all of the components of a bicycle, there is still a pressing requirement to make toothed wheels (sprockets and crowns) that are as light as possible and that allow the weight of the sprocket assembly and of the crankset to be kept as low as possible, in particular as the number of sprockets or crowns that constitute the sprocket assembly or the crankset increases.

The problem at the basis of the present invention is therefore that of making a toothed wheel of reduced weight with respect to known toothed wheels.

### SUMMARY

The present invention concerns—in a first aspect thereof—a toothed wheel of a bicycle drivetrain, having a flat shape between two opposite sides, with a central portion surrounded by a peripheral portion, in which the peripheral portion comprises a plurality of teeth intended for engagement with a chain of the bicycle drivetrain, wherein the peripheral portion comprises at least one side projection at and extending on at least one of the teeth, projecting with respect to one of the sides.

In a second aspect thereof, the present invention concerns a pair of toothed wheels of a group of toothed wheels of a bicycle drivetrain, comprising a wheel of greater diameter and a wheel of smaller diameter having a flat shape between two opposite sides, each of the wheels having a central portion surrounded by a peripheral portion, in which the peripheral portion comprises a plurality of teeth intended for engagement with a chain of the bicycle drivetrain, in which the wheel of greater diameter has an outer side facing towards the wheel of smaller diameter and an inner side opposite the outer side and comprises a first specialized tooth for upward gearshifting, wherein the outer side of the peripheral portion of the toothed wheel of greater diameter comprises a substantially flat area without recesses, situated in front with respect to the first tooth and the outside of the teeth.

In other aspects thereof, the invention concerns a sprocket assembly of a bicycle drivetrain comprising at least one toothed wheel of the invention and a sprocket assembly comprising a pair of toothed wheels of the invention.

In other aspects thereof, the invention concerns a crankset of a bicycle drivetrain comprising at least one toothed wheel of the invention and a crankset comprising a pair of toothed wheels of the invention.

In other aspects thereof, the invention concerns a gearshift group of a bicycle drivetrain comprising at least one toothed wheel of the invention and a gearshift group assembly comprising a pair of toothed wheels of the invention.

In further aspects thereof, the invention concerns a bicycle drivetrain comprising at least one toothed wheel of the invention and a bicycle drivetrain comprising a pair of toothed wheels of the invention.

### BRIEF DESCRIPTION OF THE DRAWING(S)

Further characteristics and advantages of the present invention shall become clearer from the following detailed description of some preferred embodiments thereof, made with reference to the attached drawings. In such drawings:

FIG. 1 is a front plan view of a sprocket assembly for a bicycle comprising toothed wheels according to the invention;

FIG. 2 is a front plan view of a pair of toothed wheels of the sprocket assembly of FIG. 1;

FIG. 3 is a front plan view of a toothed wheel of the pair of FIG. 2;

FIG. 4 is a view from above of the toothed wheel of FIG. 3;

FIG. 5 is a rear plan view of the toothed wheel of FIG. 3;

FIG. 6 is an enlarged view of a detail of the toothed wheel of FIG. 3;

FIGS. 7 to 14 are section views of the toothed wheel of FIG. 6 along respective section planes G-G, H-H, J-J, K-K, L-L, M-M, N-N, and P-P of FIG. 6;

FIG. 15 is a view of an enlarged detail of FIG. 6;

FIG. 16 is a section view along the plane Q-Q of FIG. 15;

FIG. 17 is a fragmentary top plan view of a detail of the toothed wheel of FIG. 3 with the chain engaged;

FIG. 18 is a view from above of the pair of toothed wheels of FIG. 2 with the chain in a first gearshifting condition;

FIG. 19 illustrates the pair of toothed wheels of FIG. 18 with the chain in the first gearshifting condition;

FIG. 20 is a view from above of the pair of toothed wheels of FIG. 2 with the chain in a second gearshifting condition;

FIG. 21 illustrates the pair of toothed wheels of FIG. 20 with the chain in the second gearshifting condition;

FIG. 22 is a front plan view of a second pair of toothed wheels of the sprocket assembly of FIG. 1;

FIG. 23 is a front plan view of a toothed wheel of the pair of FIG. 22;

FIG. 24 is an enlarged view of a detail of FIG. 23;

FIG. 25 is a section view of the toothed wheel of FIG. 23, along the section plane T-T;

FIG. 26 is a view from above of the pair of toothed wheels of FIG. 22 with the chain in a first gearshifting condition;

FIG. 27 is an axonometric view of the pair of toothed wheels of FIG. 26 with the chain in the first gearshifting condition;

FIG. 28 is a view from above of the pair of toothed wheels of FIG. 22 with the chain in a second gearshifting condition;

FIG. 29 is an axonometric view of the pair of toothed wheels of FIG. 28 with the chain in the second gearshifting condition; and

FIG. 30 is a view of a variant of the detail of FIG. 15.

### DETAILED DESCRIPTION OF THE PREFERRED EMBODIMENT(S)

### Introduction

The present invention concerns—in a first aspect thereof—a toothed wheel of a bicycle drivetrain, having a flat shape between two opposite sides, with a central portion surrounded by a peripheral portion, in which the peripheral portion comprises a plurality of teeth intended for engagement with a chain of the bicycle drivetrain, wherein the peripheral portion comprises at least one side projection at and extending on at least one of the teeth, projecting with respect to one of the sides. The presence of the projection provides the necessary guide for the chain and therefore the stability of the coupling between the chain and the toothed wheel without, however, making the toothed wheel itself heavier with an excessive thickness in all of its parts; in other words, the minimum thickness necessary so that the guiding of the chain takes place in an adequate way is limited to just the zone of the projection, whereas the rest of the toothed wheel can have a smaller thickness. The projection therefore provides a sort of “apparent thickness” for the chain, greater than the real thickness responsible for the weight of the toothed wheel.

Preferably, the entire toothed wheel—both the central portion and the peripheral portion, with the exception of the at least one projection—is defined on its two sides by two parallel planes.

Preferably, the toothed wheel is intended to form part of a group of adjacent toothed wheels; the sides therefore comprise an outer side, intended to face towards a toothed wheel of smaller diameter or else to define the group of toothed wheels towards the outside, and an inner side, intended to face towards a toothed wheel of greater diameter or else to define the group of toothed wheels towards the inside; the at least one projection preferably projects from the outer side.

Preferably, the number of teeth at which the at least one projection is provided is less than the total number of teeth of the wheel. Indeed, it is not necessary for the function of “apparent thickness” provided by the projections to be present at each tooth, but it is sufficient for it to be provided at some of the teeth so that the chain is guided correctly.

Although many projections could be provided on each tooth, it is preferable to provide just one. Forming many projections would make manufacturing more complex and expensive, and there is currently no reason to believe it would provide significant functional advantages.

Each of the aforementioned projections can be formed on the toothed wheel in various ways. Preferably, the at least one projection is obtained through displacement of material of the peripheral portion of the toothed wheel; such displacement is carried out for example and preferably through material working technologies such as a stamping process, preferably coining, embossing, or similar operation. This method is preferred both because it is constructively simple, and because it allows the weight of the toothed wheel to be further reduced due to the lack of material occurring on the side of the toothed wheel, on the opposite side to the projection.

Preferably, the toothed wheel comprises a through opening at the at least one projection, more preferably in the form of a circular cylindrical hole, having its axis parallel to the axis of the toothed wheel. A further lightening of the toothed wheel can thus be achieved. Even more preferably, the at least one projection is obtained by a stamping process, preferably coining (or else embossing or similar procedure) together with the opening, thus without substantial manufacturing complication.

The shape of the projection can be of different types. Preferably, the projection is elongated in shape, with a greater extension in the radial direction than in the circumferential direction. A certain extension in the radial direction is used to ensure the best guide to the chain, whereas in the circumferential direction an even minimal extension is sufficient.

Preferably, the projection comprises a first radially inner portion, a second radially outer portion having a smaller circumferential size than the radially inner portion, and a through hole formed in the radially inner portion, the hole having a circular cylindrical shape with an axis parallel to the axis of the toothed wheel. This configuration is advantageous because it allows the rigidity of the tooth to be increased, in particular when the first and second portion are obtained by a stamping process, preferably coining (or similar procedure) since a ribbing is formed that, as known, allows the rigidity of the material to be increased opposing the bending of the tooth. Moreover, such a configuration advantageously allows the through opening to be made in the second portion that is subject to less stresses with respect to the first portion. The first portion remains substantially integral.

Preferably, the projection is fitted to the side of the toothed wheel through a peripheral beveling; the beveling is useful for having as homogeneous as possible distribution of the mechanical stresses in the material of the toothed wheel, and also promotes a contact without jamming with the parts of the chain.

A wheel having a projection in accordance with the invention, as stated, advantageously allows the lack of material in the vicinity of the projection to be useful to ease the gearshifting operations in a group of many toothed wheels (sprocket assembly or crankset).

In a second aspect thereof, the present invention concerns a pair of toothed wheels of a group of toothed wheels of a bicycle drivetrain, comprising a wheel of greater diameter and a wheel of smaller diameter having a flat shape between two opposite sides, each of the wheels having a central portion surrounded by a peripheral portion, in which the peripheral portion comprises a plurality of teeth intended for engagement with a chain of the bicycle drivetrain, in which the wheel of greater diameter has an outer side facing towards the wheel of smaller diameter and an inner side opposite the outer side and comprises a first specialized tooth for upward gearshifting, wherein the outer side of the peripheral portion of the toothed wheel of greater diameter comprises a substantially flat area without recesses, situated in front with respect to the first tooth and outside of the teeth.

It should be noted that according to this aspect of the invention it is not necessary for any side projection to be provided.

Finally, in further aspects thereof the invention concerns a sprocket assembly, a crankset, a gearshift group and a bicycle drivetrain.

### Description

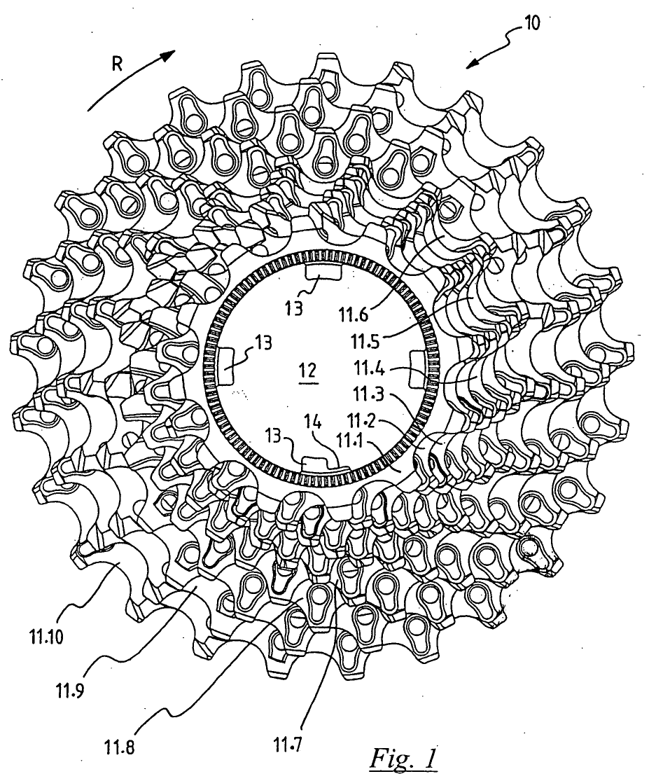

In FIG. 1 a group of toothed wheels formed by a sprocket assembly is represented, generally indicated with 10, which comprises ten side-by-side coaxial sprockets (generally indicated with 11 or else specifically with 11.1-11.10) having, from the smallest to the largest, an increasing number of teeth according to the following sequence: 12, 13, 14, 15, 16, 17, 19, 21, 23, 25.

From the first sprocket 11.1 with 12 teeth to the sixth sprocket 11.6 with 17 teeth, the increase in teeth from one sprocket to the next is by one tooth, commonly known as skip one (symbolically (Δ1)), whereas from the sixth sprocket 11.6 with 17 teeth to the tenth sprocket 11.10 with 25 teeth the increase in teeth from one sprocket to the next is by two teeth, commonly known as skip two (symbolically (Δ2)).

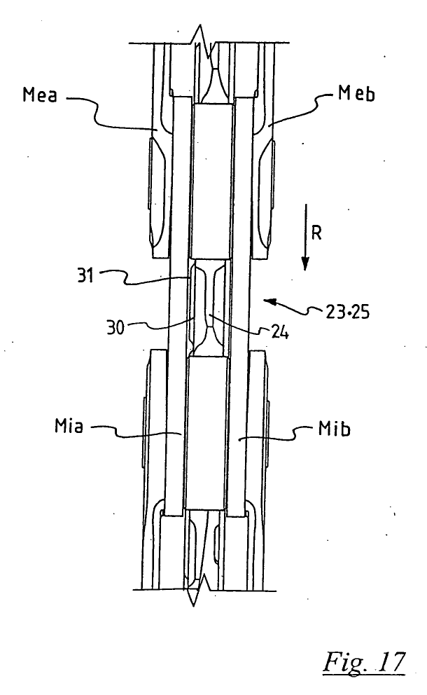

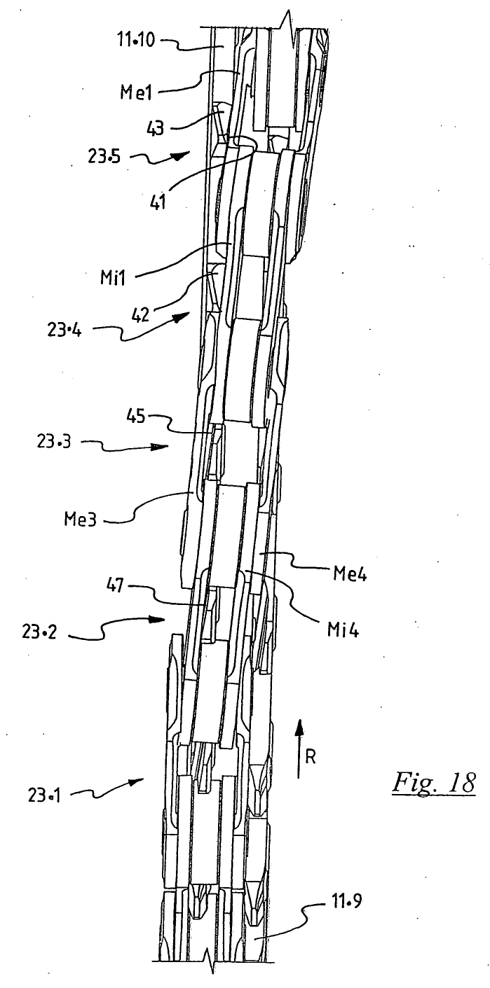

The sprocket assembly 10 is intended for assembly on a sprocket holding body, not shown in the figures, belonging to a free wheel mechanism associated with the rear wheel of a bicycle. The sprockets 11 are each provided with a central through hole 12 through which they are coupled on the outer surface of the sprocket holding body. To ensure locking against rotation of each sprocket 11 on the sprocket holding body, according to a common technique in the field, projecting fins 13 that match with respective and corresponding grooves of the sprocket holding body are formed on the central hole 12 of each sprocket 11. To ensure the desired angular phasing between the various sprockets 11, the fins 13 comprise a key 14, formed by an indentation in one of the fins 13. The phasing allows two adjacent sprockets to be positioned in a relative predetermined angular position to assist, in particular, the passage of the chain K (chain K is shown, e.g., in FIGS. 17-21 and 26-29) from one sprocket 11 of smaller diameter to an adjacent sprocket of greater diameter (upward gearshifting).

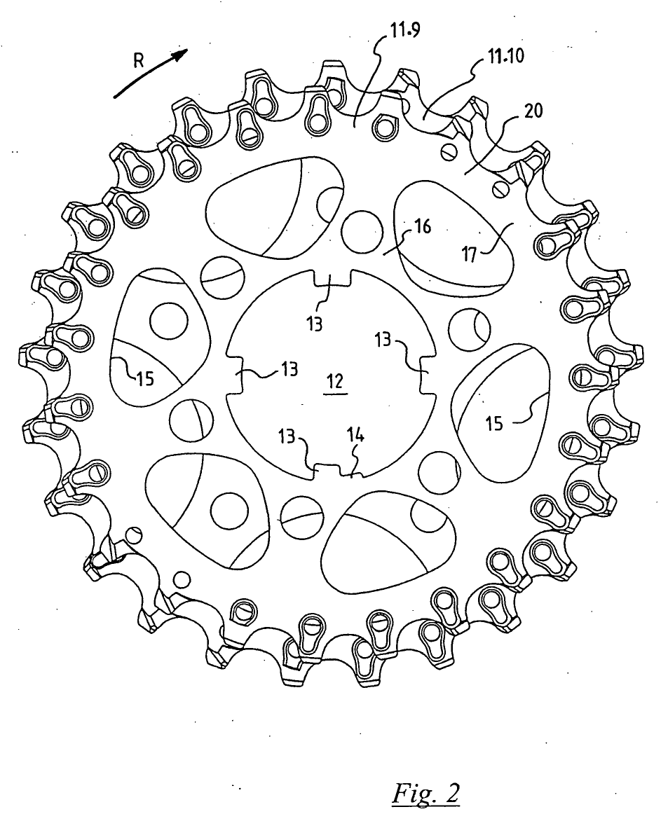

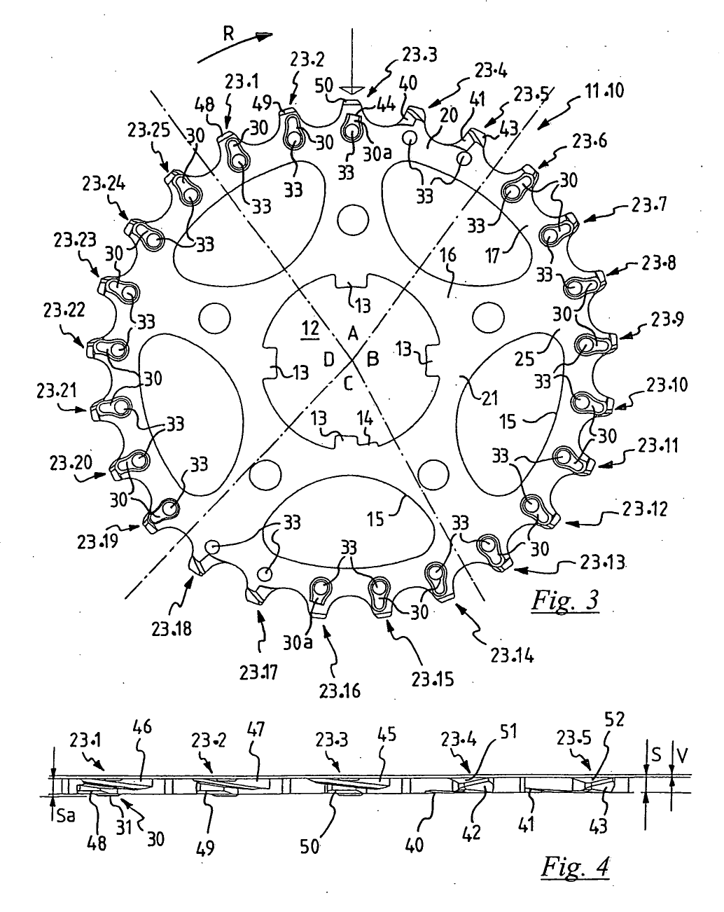

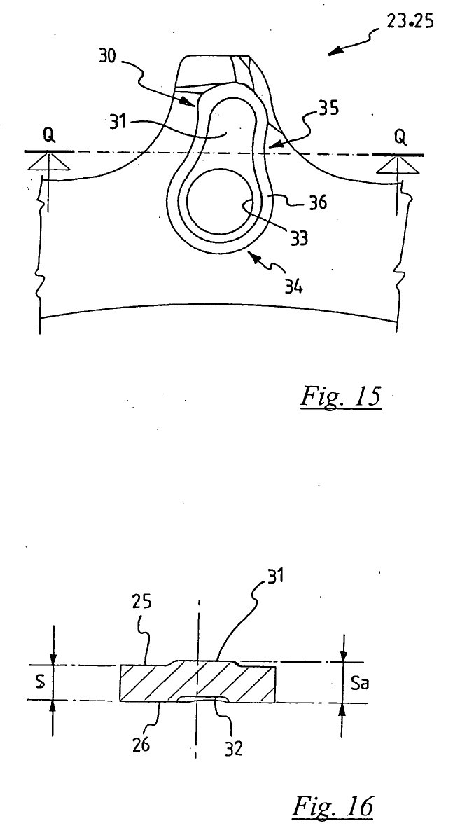

In FIG. 2 the pair of sprockets 11.9, 11.10 with skip two (Δ2) is represented having, respectively, 23 and 25 teeth and arranged according to the desired angular phasing. FIGS. 3 to 15 show just the sprocket 11.10 of greater diameter of the pair with skip two (Δ2) of FIG. 2, i.e., the sprocket with 25 teeth. In the sprocket assembly represented here, the four sprockets 11.7-11.10 with 19, 21, 23 and 25 teeth, i.e. the sprockets of greater diameter with skip two (Δ2), are substantially the same as each other, except for the different diameter and number of teeth. The description shall be made, therefore, just for the represented sprocket 11.10 with 25 teeth, meaning that this is also valid for the other sprockets.

The sprocket 11.10 comprises a central portion 16 and a substantially annular peripheral portion 17, which surrounds the central portion 16.

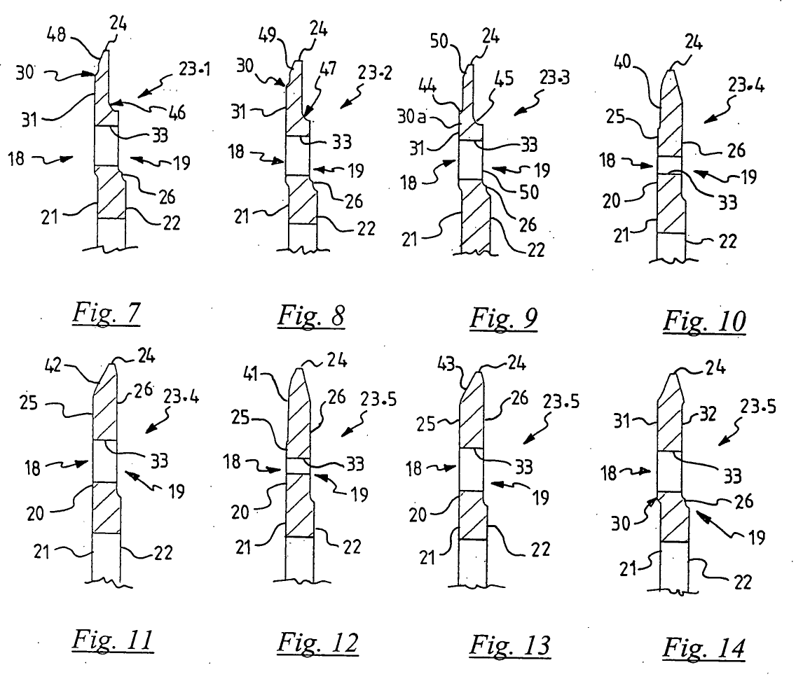

In the central portion 16 the central hole 12 is formed with the fins 13; moreover, the central portion 16 is provided with some lightening openings 15 and has a predetermined thickness S between two opposite sides 18 and 19 of the sprocket 11 (represented in FIGS. 7-14), outer and inner respectively, formed by respective parallel planes 21 and 22 (represented in FIGS. 7-14).

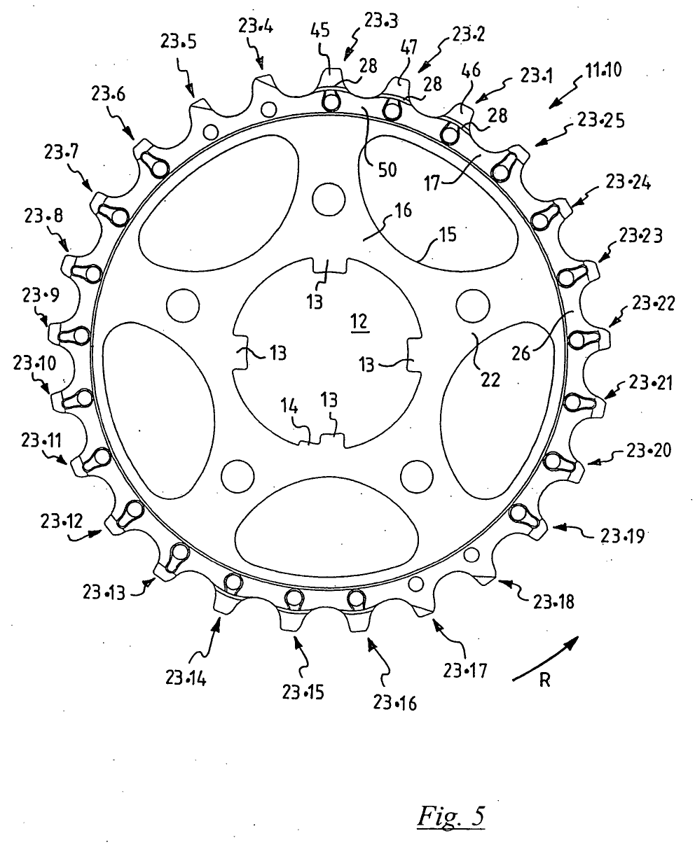

The peripheral portion 17 comprises twenty-five teeth (generally indicated with 23 or else specifically with 23.1-23.25) for meshing with the chain K. The peripheral portion 17 is defined on the two sides 18 and 19 by two parallel planes 25 and 26 (represented in FIGS. 7-14), outer and inner respectively. The inner plane 26 is lowered by an amount V with respect to the inner plane 22 of the central portion 16 (FIG. 5 and FIG. 14 section P-P), for example through turning or other mechanical processing. Such lowering allows the sides 18 and 19 of the adjacent sprockets 11 to be better spaced apart, increasing the distance between the inner plane 26 of the teeth 23 of a sprocket 11 with respect to the outer plane of the teeth 23 of the adjacent sprocket 11. This avoids the chain K interfering against the adjacent sprockets 11 during the rotation of the sprocket assembly 10.

The twenty-five teeth 23 are grouped in four sectors A, B, C, D (as represented in FIG. 3) in which:
the sectors A and C, identical to each other, each comprise five specialized teeth (23.1-23.5 and 23.14-23.18) for upward gearshifting;
the sector B comprises eight unspecialized or neutral teeth 23.6-23.13; and
the sector D comprises seven unspecialized or neutral teeth 23.19-23.25.

As can be seen in FIG. 3, all of the teeth 23 of the sprocket 11.10, except for two teeth 23.4, 23.5 of the sector A and two teeth 23.17, 23.18 of the sector C, are provided with a projection 30 projecting sideways with respect to the outer plane 25 of the peripheral portion 17 of the sprocket 11.10 itself. The projection 30 defines a projecting outer surface 31 substantially parallel to the surface of the outer plane 21 of the central portion 16 (FIGS. 7, 8, 9, 14, 16). Each projection 30 extends from the tooth 23 in the peripheral portion 17 towards the center of the sprocket 11.10 and its dimension in the circumferential direction increases approaching the center of the sprocket 11.10, assuming an approximately pear-like shape, with rounded contour having zones with convex curvature alternating with zones with concave curvature; in this way, the projection 30 comprises a radially inner portion 34 with a greater size in the circumferential direction than a radially outer portion 35. Moreover, the projection 30 comprises a peripheral beveling 36 that surrounds it.

The projection 30 is obtained, preferably, by displacement of the material (stamping or coining) of the peripheral portion 17 towards the outside, as can be seen in particular in FIG. 14 with reference to the section of the neutral tooth 23.25; advantageously, the projection 30 is thus obtained without addition of material, and therefore without increasing the weight of the peripheral portion 17 itself.

The neutral tooth 23.25 is therefore of variable thickness and, as can be seen in the detail of FIG. 16, situated between the projecting outer surface 31 of the projection 30 and the inner plane 26 of the peripheral portion 17. Between the surface 31 and the plane 26 an apparent thickness indicated with Sa of the tooth 23.25 is thus defined. Indeed, the surface 31 and the plane 26 define the guide for the chain K, in particular for the facing inner pairs of links Mia, Mib (FIG. 17) that are connected through pins to the facing outer pairs of links Mea, Meb, thus forming respective portions of the chain K. The inner plane 26 of the neutral tooth 23.25 has a recessed central zone 32, a consequence of the cited stamping or coining process (as can be seen in FIG. 16). Consequently, the thickness value necessary for the specific chain K used is Sa and not S.

Advantageously, therefore, the teeth 23, the peripheral portion 17, and the central portion 16 of the sprocket 11 do not consist of a body having the same thickness Sa all over, as occurs for the prior art; the apparent thickness Sa necessary for the guiding of the chain K is limited at most to the zones in which the projections 30 are provided whereas elsewhere the thickness is smaller, with consequent reduction in the weight of the sprocket 11 itself. Indeed, if the projections 30 are obtained by displacement of material as indicated in the example, the real thickness S of the sprocket 11 is less than Sa all over.

In variant embodiments, the inner plane 26 of the peripheral portion 17 could be flat and not have the recessed central zone 32 of the projection 30 (providing other types of processes different from stamping or coining, for example, starting from a sprocket of greater thickness and removing material on the outer side 18 apart from at the projections 30).

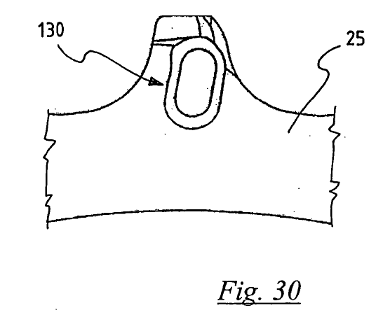

Equally, the projecting outer surface 31 of the projection 30 could have a different shape and engage the tooth 23 and the outer plane 25 of the peripheral portion 17 of the sprocket 11 with different geometries. In FIG. 30, for example, a projection is shown, indicated with 130, according to a shape variant with respect to the projection 30. With respect to the projection 30, the projection 130 has a simpler rounded shape, without zones with concave curvature and without a differentiation between a radially inner portion and a radially outer portion.

In each tooth 23, at each projection 30, a through hole 33 for further lightening is made. The through hole 33 creates a cylindrical surface parallel to the axis of the sprocket 11; such a surface, following the hardening treatments to which the surfaces of the sprocket 11 are subjected (for example, cementation), allows the structural strength of the sprocket 11 to be increased in its axial direction.

The outer plane 25 of the peripheral portion 17 where there are no projections 30 is aligned with the outer plane 21 of the central portion 16 (FIGS. 10-13).

As stated above, on the sprocket 11.10 two sectors A and C are defined provided with specialized teeth 23.1-23.5 and 23.14-23.18; such sectors A and C define two zones inside a round angle in which the lifting of the chain K from the immediately adjacent sprocket 11.9 of smaller diameter (i.e. upward gearshifting towards the sprocket 11.10) is made easier.

It should be noted that, in a simplified variant embodiment, a sprocket 11 (for example, the sprocket 11.1 of minimum diameter, towards which no upward gearshifting is possible) could lack facilitation sectors and in such a case each tooth 23 of such a sprocket 11 could be of the neutral type described above.

Hereafter, reference shall be made to the five specialized teeth 23.1-23.5 of the sector A, being the same as those of the sector C. Moreover, the terms “rear” or “next” and “front” or “preceding” shall be used with reference to the normal direction of rotation, indicated with R, i.e., the direction defined by the rotation of the sprocket assembly 10 during pedaling forwards.

At the specialized teeth 23.5 and 23.4, the outer plane 25 of the peripheral portion 17 of the sprocket 11.10 is without the projection 30 and thus comprises a front area 20 with respect to the tooth 23.3, which is substantially flat and without recesses, aligned with the outer plane 21 of the central portion 16 (as can be seen in particular in FIGS. 11 and 13—sections L-L and N-N, respectively). Such an area 20 without any projection makes a part on the peripheral portion 17 for facilitating upward gearshifting when the chain K is pushed by the rear derailleur from the sprocket 11.9 towards the sprocket 11.10, as shall be seen more clearly hereafter.

On the outer side 18 of the tooth 23.4 and of the tooth 23.5, respective first outer bevelings 40, 41 (as shown in FIG. 4) are formed and defined by oblique surfaces that approach the middle plane of the sprocket 11.10 proceeding in the direction opposite the normal direction of rotation R. Such first outer bevelings 40 and 41 involve about half of the tooth 23.4, 23.5 starting from its center going towards the rear zone thereof. The first outer beveling 41 of the tooth 23.5 is slightly more accentuated than the first outer beveling 40 of the tooth 23.4 (see FIG. 4).

Again, on the outer sides 18 of the teeth 23.4 and 23.5, respective second outer bevelings 42, 43 (as shown in FIG. 4) are formed that involve the tooth 23.4 and 23.5 towards the respective crest 24 and give the crest 24 of the tooth, as can be seen in FIG. 14, an inclined progression with respect to the middle plane of the sprocket 11.10. Such second outer bevelings 42, 43 are defined by oblique surfaces that approach the middle plane of the sprocket 11.10 going in the normal direction of rotation R.

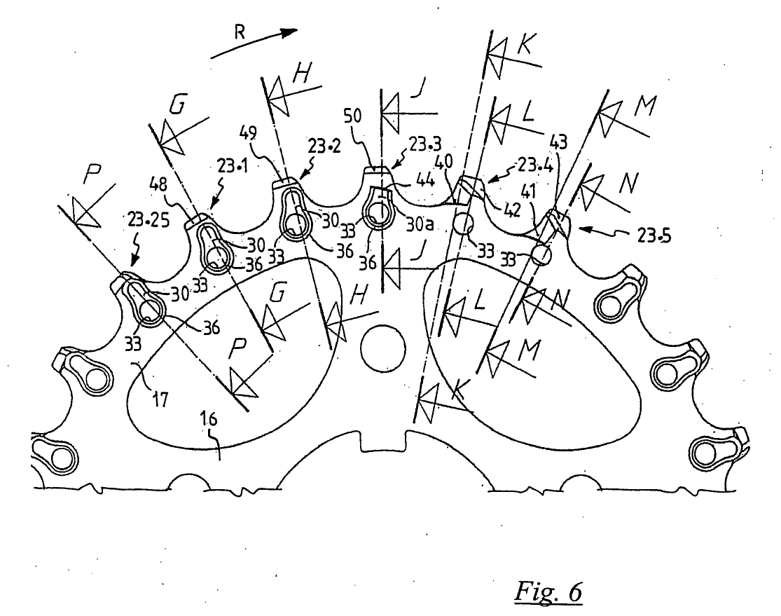

The tooth 23.3 is provided with a projecting projection 30a, similar to the projections 30 described above but truncated at the top, towards the crest 24 of the tooth 23.3, by a slightly inclined edge 44 (see in FIG. 6 and section J-J of FIG. 9), with a progression that goes away from the center of the sprocket 11.10 going in the direction opposite the advancing direction R.

On the inner side 19, the tooth 23.3 is provided with an inner beveling 45 (as shown in FIG. 4) defined by an oblique surface that approaches the middle plane of the sprocket 11.10 going in the normal direction of rotation R, and which extends between the crest 24 of the tooth 23.3 and a chord 28 close to the base of the tooth itself.

The teeth 23.1, 23.2 are also provided, on the inner side 19, with respective inner bevelings 46, 47 (as shown in FIG. 4); the depth with respect to the middle plane of the sprocket 11.10 of each of the inner bevelings 45, 47 and 46 of the respective teeth 23.3, 23.2 and 23.1 is less than that of the beveling of the previous tooth, with respect to the direction R. In variant embodiments, however, the depths of the bevelings 45, 46 and 47 can be the same.

The bevelings 45, 46 and 47 of the teeth 23.3, 23.2 and 23.1 together make a depression zone on the inner side 19 of the sprocket 11.10.

On the inner side 19, around the tooth 23.3, the peripheral portion 17 of the sprocket 11.10 comprises an area 50 outside of the teeth 23 that is substantially flat, without any recess.

Moreover, the specialized teeth 23.1-23.5 are provided with apical bevellings at their own crest 24; in particular, the tooth 23.1 comprises an apical bevelling 48 on the outer side 18, the tooth 23.2 comprises an apical beveling 49 on the outer side 18, the tooth 23.3 comprises an apical beveling 50 on the outer side 18, the tooth 23.4 comprises an apical beveling 51 on the inner side 19, and the tooth 23.5 comprises an apical beveling 52 on the inner side 19 (as shown in FIG. 4).

The functions of the five specialized teeth 23.1-23.5 and of the respective bevelings and edges 40-46 are described hereafter with reference to two upward gearshifting conditions of the chain K from the sprocket 11.9 with 23 teeth to the sprocket 11.10 with 25 teeth. The two gearshifting conditions correspond to the two different situations that can be created during gearshifting with reference to the position of the chain K with respect to the sprocket of smaller diameter 11.9, i.e., either if, considering the same tooth 23 of such a sprocket 11.9, it is engaged by a portion of chain K defined by two of its facing inner links or, on the other hand, if it is engaged by a portion of chain K defined by two of its facing outer links.

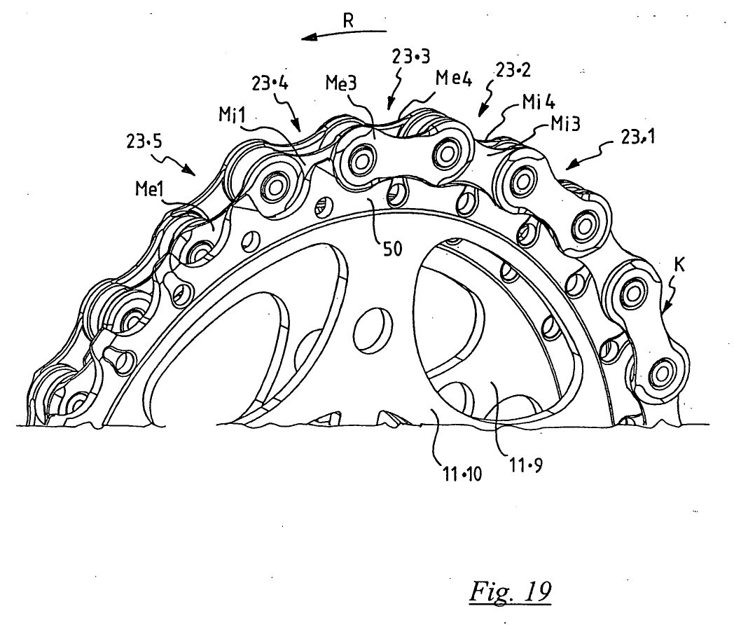

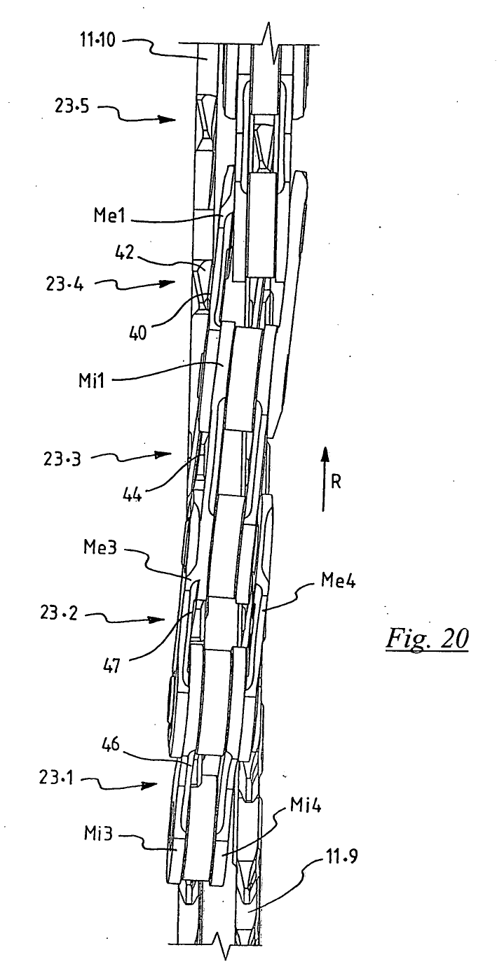

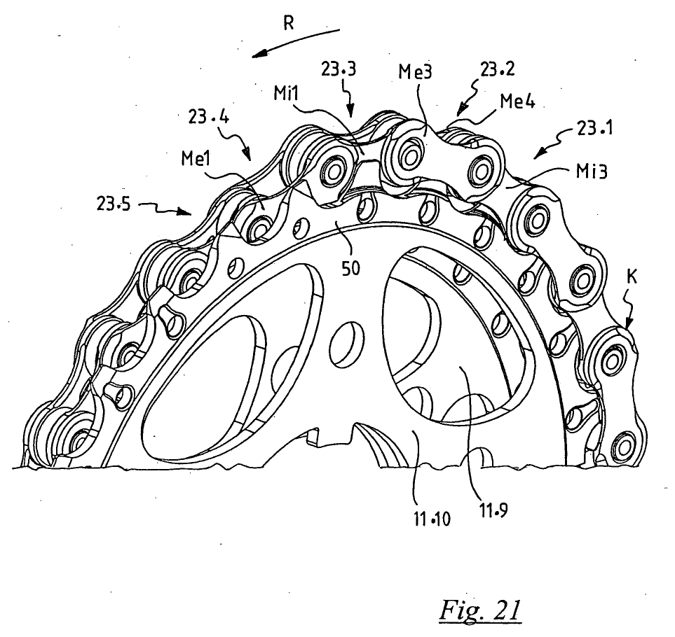

The first gearshifting condition of the two cited conditions, in which the chain K leaves the sprocket 11.9 with 23 teeth to engage the sprocket 11.10 with 25 teeth, is shown in FIGS. 18 and 19.

The outer link Me1 of the chain K makes contact with the flat area 20 of the peripheral portion 17 below the tooth 23.5 and rests on its first outer beveling 41. The second outer beveling 43 of the tooth 23.5 makes the outer link Me1 of the chain K slide, preventing it from engaging with the tooth 23.5 itself (therefore, this is substantially a refusal beveling). The inner link Mi1 makes contact with the tooth 23.4 and rests on its first outer beveling 40. The tooth 23.3 is engaged by the portion of chain K formed by the two outer links Me3 and Me4 and the outer link Me3 rests upon the inner beveling 45 of the tooth 23.3.

The tooth 23.2 is engaged by the portion of chain K formed by the two inner links Mi3 and Mi4 and the inner link Mi3 rests upon the inner beveling 47 of the tooth 23.2.

The fifth specialized tooth 23.1 is not substantially involved in this gearshifting.

It should be noted that the various previous indications Mix and Mex are meant with reference to the gearshifting position illustrated and do not therefore indicate the specific links of the chain K. The same indications shall also be used hereafter to illustrate other gearshifting conditions, without reference to specific links of the chain K.

The second gearshifting condition of the two conditions cited above is shown in FIGS. 20 and 21.

The outer link Me1 of the chain K makes contact with the flat area 20 of the peripheral portion 17 below the tooth 23.4 and rests upon its first outer beveling 40. The second outer beveling 42 of the tooth 23.4 makes the outer link Me1 of the chain K slide, preventing it from engaging with the tooth 23.4 itself (therefore, this is substantially a refusal beveling). The inner link Mi1 makes contact with the tooth 23.3 and rests on the edge 44 of the truncated projection 30a. The tooth 23.2 is engaged by the portion of chain K formed by the two outer links Me3 and Me4 and the outer link Me3 rests upon the inner beveling 47 of the tooth 23.2.

The tooth 23.1 is engaged by the portion of chain K formed by the two inner links Mi3 and Mi4 and the inner link Mi3 rests upon the inner beveling 46 of the tooth 23.1.

The fifth specialized tooth 23.5 is not substantially involved in this gearshifting.

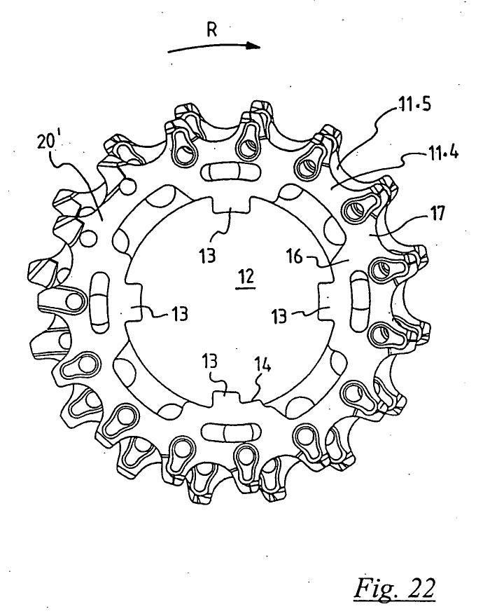

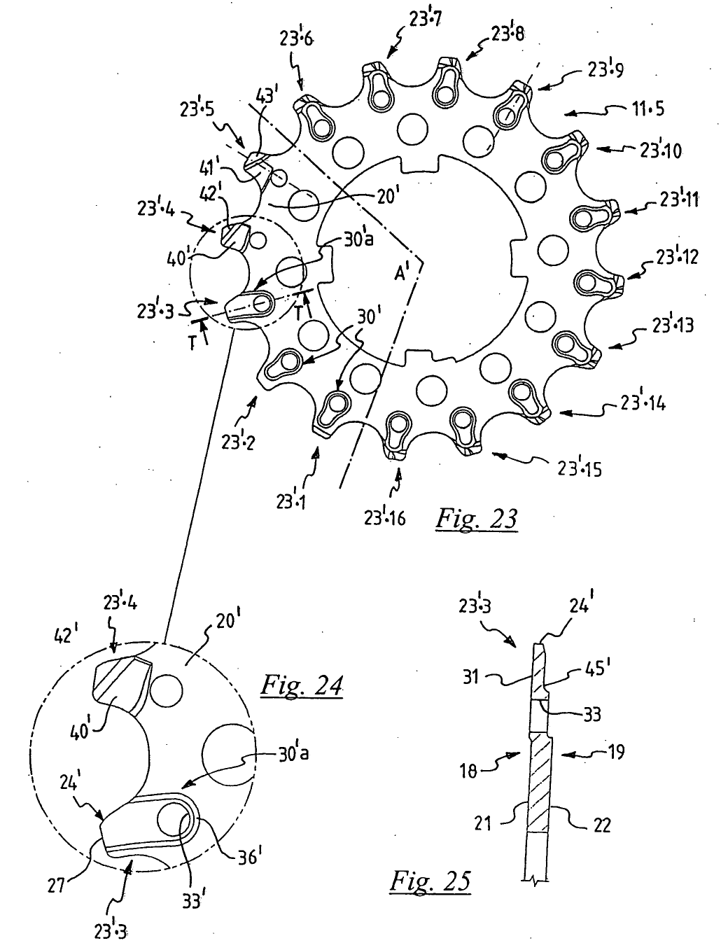

In FIG. 22, the pair of sprockets 11.4, 11.5 with skip one (Δ1) is represented having, respectively, 15 and 16 teeth and arranged according to the desired angular phasing. In FIG. 23, just the sprocket 11.5 of greater diameter of the pair with skip one (Δ1) of FIG. 22, i.e., the sprocket with 16 teeth, is shown. In the sprocket assembly 10 represented here, the five sprockets 11.2-11.6 with 13, 14, 15, 16, and 17 teeth, i.e., the sprockets of greater diameter in a skip one (Δ1), are substantially the same as each other, apart from the different diameter and number of teeth. The description will be made, therefore, only for the sprocket 11.5 with 16 teeth represented. The sprocket of minimum diameter 11.1 with 12 teeth of the sprocket assembly 10 is, on the other hand, different from the others since it is not subject to being engaged by the chain K in upward gearshifting operations. Such a sprocket 11.1 can therefore also be of known type.

The sprocket 11.5 with 16 teeth differs from the sprocket 11.10 with 25 teeth described above, in addition to the different diameter and the different number of teeth, in that it has just one sector A′ provided with five specialized teeth 23′.1-23′.5 and for the different embodiment of the projection 30′a of the specialized tooth 23′.3. The details of the sprocket 11.5 corresponding to details of the sprocket 11.10 described previously shall not be described in detail and shall be indicated hereafter by the same reference numerals used for the sprocket 11.10, with the addition of an apostrophe (′).

The projection 30′a of the specialized tooth 23′.3 of the sprocket 11.5, unlike the truncated projection 30a of the specialized tooth 23.3 of the sprocket 11.10, extends up to the crest 24′ of the tooth 23′.3, as can be seen more clearly in the section of FIG. 25, determining a support zone 27 on top of the tooth 23′.3 itself.

Such a support zone 27 is used in the gearshifting step that, as shall be illustrated hereafter, in the case of skip one (Δ1), takes place in a slightly different way compared to the skip two (Δ2) described above, given the smaller difference in diameter of the two sprockets 11.4, 11.5 and their different phasing.

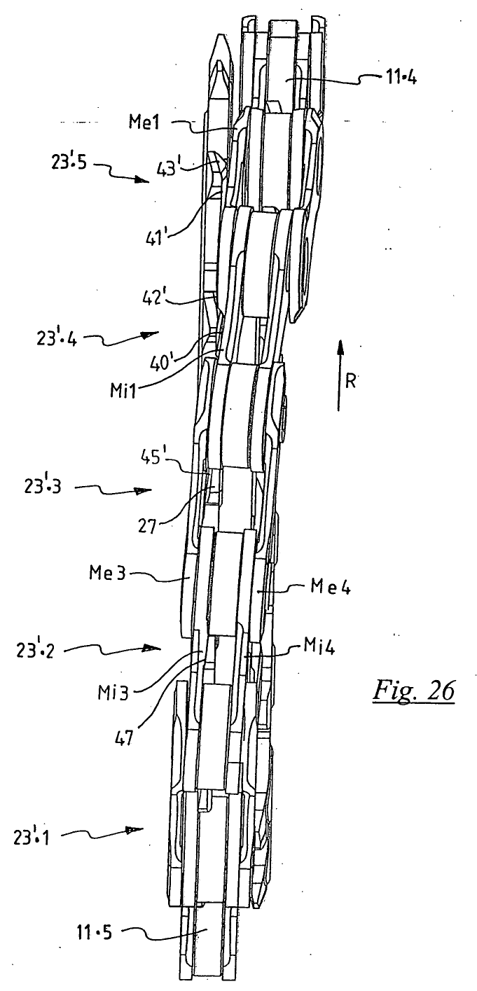

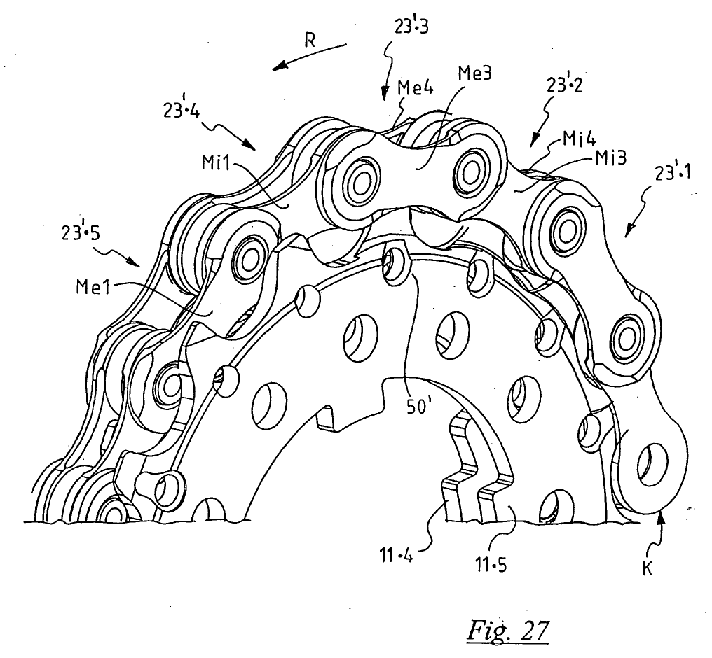

The first gearshifting condition is illustrated hereafter with reference to FIGS. 26 and 27.

The outer link Me1 of the chain K makes contact with the area 20′ of the peripheral portion 17 below the tooth 23′.5 and rests upon its first outer beveling 41′. The second outer beveling 43′ of the tooth 23′.5 makes the outer link Me1 of the chain K slide, preventing it from engaging with the tooth 23′.5 itself. The outer link Me1 also makes contact with the tooth 23′.4 and rests upon its second outer beveling 42′, whereas the inner link Mi1 makes contact with its first outer beveling 40′. The inner link Mi1 is positioned with its final part above the support zone 27 of the tooth 23′.3 in a slightly raised position.

The tooth 23′.2 is engaged by the portion of chain K formed by the two inner links Mi3 and Mi4 and the inner link Mi3 rests upon the inner beveling 47′ of the tooth 23′.2.

From such a condition, after a slight rotation of the sprocket assembly 10, the outer link Me3 slides on the inner side 19 of the tooth 23′.3 at its inner beveling 45′ and the portion of chain K consisting of the outer links Me3 and Me4 from the slightly raised position descends to completely engage the tooth 23′.3.

The fifth specialized tooth 23′.1 is not substantially involved in this gearshifting.

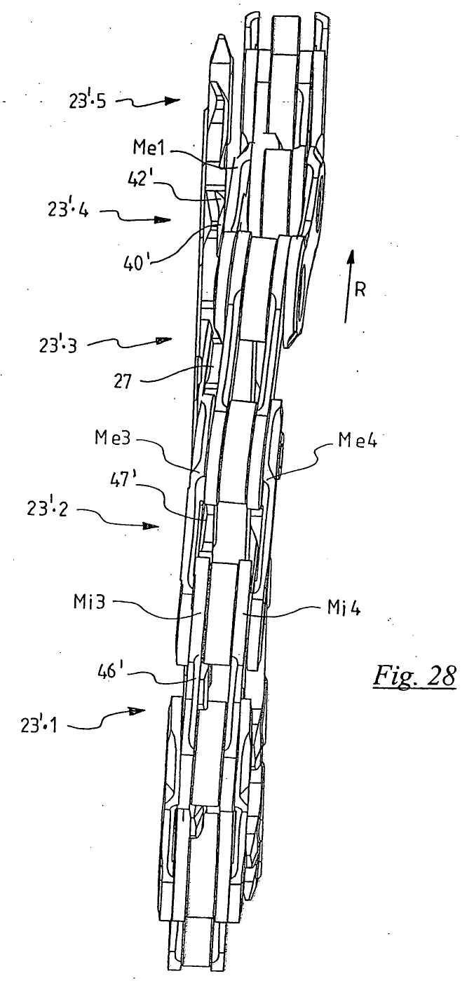

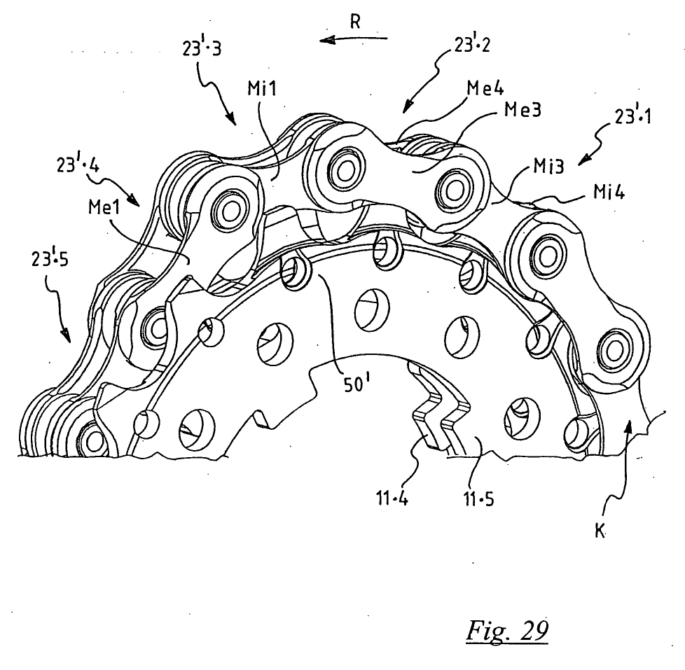

The second gearshifting condition is illustrated hereafter with reference to FIGS. 28 and 29.

The outer link Me1 of the chain K makes contact with the area 20′ of the peripheral portion 17 below the tooth 23′.4 and rests upon its first outer beveling 40′. The second outer beveling 42′ of the tooth 23′.4 makes the outer link Me1 of the chain K slide, preventing it from engaging with the tooth 23′.4. The outer link Me1 also makes contact with the tooth 23′.3 and is positioned near to the support zone 27 of the tooth 23′.3 in a slightly raised position. The tooth 23′.2 is engaged by the portion of chain K formed by the two outer links Me3 and Me4 and the outer link Me3 rests upon the inner beveling 47′ of the tooth 23′.2.

The tooth 23′.1 is engaged by the portion of chain K consisting of the two inner links Mi3 and Mi4 and the inner link Mi3 rests upon the inner beveling 46′ of the tooth 23′.1.

The fifth specialized tooth 23′.5 is not substantially involved in this gearshifting.

The present invention, of course, can be implemented in ways that are different from those exemplified in this description. For example, it is possible to apply it to pairs of toothed wheels having skip three, i.e. with a difference of three teeth between the two adjacent wheels; in such a case, three angular sectors of specialized teeth for upward gearshifting shall be defined on the toothed wheel of greater diameter. Moreover, as already stated previously, the invention is applicable not only to groups of toothed wheels formed by sprockets of a rear gearshift, but also to groups of toothed wheels formed by crowns of a front gearshift.

What is claimed is:

1. Toothed wheel of a bicycle drivetrain, having a flat shape between two opposite sides (18, 19), with a central portion (16) surrounded by a peripheral portion (17), in which the peripheral portion (17) comprises a plurality of teeth (23; 23′) intended for engagement with a chain (K) of the bicycle drivetrain, wherein the peripheral portion (17) comprises at least one side projection (30, 30a; 30b; 130) at and extending on at least one of the teeth (23; 23′), projecting with respect to one of said sides (18, 19).

2. Toothed wheel according to claim 1, intended to form part of a group (10) of adjacent toothed wheels (11), in which the sides comprise an outer side (18), intended to face towards a toothed wheel (11) of smaller diameter or else to define the group (10) of toothed wheels (11) towards the outside, and an inner side (19), intended to face towards a toothed wheel (11) of greater diameter or else to define the group (10) of toothed wheels (11) towards the inside, in which said at least one projection (30, 30a; 30b; 130) projects from the outer side (18).

3. Toothed wheel according to claim 1, wherein the number of teeth (23; 23′) at which said at least one projection (30, 30a; 30b; 130) is provided is less than the total number of teeth (23; 23′) of the wheel (11).

4. Toothed wheel according to claim 1, wherein at each tooth (23; 23′) at most one said projection is provided.

5. Toothed wheel according to claim 1, wherein each of said at least one projection (30, 30a; 30b; 130) is obtained through displacement of material of the peripheral portion (17) of the toothed wheel (11).

6. Toothed wheel according to claim 5, wherein the displacement of material is obtained by stamping, coining, or embossing.

7. Toothed wheel according to claim 1, further comprising a through opening (33) at said at least one projection (30, 30a; 30b).

8. Toothed wheel according to claim 7, wherein the through opening is a circular cylindrical hole (33), having its axis parallel to the axis of the toothed wheel (11).

9. Toothed wheel according to claim 7, wherein said at least one projection (30, 30a; 30b) is obtained by stamping, coining, or embossing together with said opening (33).

10. Toothed wheel according to claim 1, wherein said at least one projection (30, 30a; 30b; 130) has an elongated shape, with a greater extension in the radial direction than the extension in the circumferential direction.

11. Toothed wheel according to claim 10, wherein said at least one projection (30, 30a; 30b) comprises a first radially inner portion (34), a second radially outer portion (35) having a smaller circumferential size than the radially inner portion (34), and a through hole (33) formed in the radially inner portion (34), said hole (33) having a circular cylindrical shape with its axis parallel to the axis of the toothed wheel (11).

12. Toothed wheel according to claim 1, wherein said projection (30, 30a; 30b; 130) is fitted to said side (18) of the toothed wheel (11) through a peripheral beveling (36).

13. Toothed wheel according to claim 1, wherein the entire toothed wheel (11)—both the central portion (16) and the peripheral portion (17), with the exception of said at least one projection (30, 30a; 30b; 130)—is defined on its two sides (18, 19) by two parallel planes (25, 26).

14. Pair of toothed wheels of a group of toothed wheels of a bicycle drivetrain, comprising a wheel (11) of greater diameter and a wheel (11) of smaller diameter having a flat shape between two opposite sides (18, 19), each of the wheels (11) having a central portion (16) surrounded by a peripheral portion (17), wherein the peripheral portion (17) comprises a plurality of teeth (23; 23′) intended for engagement with a chain (K) of the bicycle drivetrain, wherein the wheel (11) of greater diameter has an outer side (18) facing towards the wheel (11) of smaller diameter and an inner side (19) opposite the outer side (18) and comprises a first specialized tooth (23.3; 23′.3) for upward gearshifting, wherein the outer side (18) of the peripheral portion (17) of the toothed wheel (11) of greater diameter comprises a substantially flat area (20; 20′) without recesses, situated in front with respect to said first tooth (23.3; 23′.3) and outside of the teeth (23; 23′).

15. Pair of toothed wheels according to claim 14, wherein said first specialized tooth (23.3; 23′.3) for upward gearshifting comprises at least one inner beveling (45; 45′) on the inner side (18).

16. Pair of toothed wheels according to claim 14, wherein the inner side (19) of the peripheral portion (17) of the toothed wheel (11) of greater diameter comprises a substantially flat area (50; 50′) without recesses around said first tooth (23; 23′).

17. Pair of toothed wheels according to claim 14, wherein said substantially flat area (20) without recesses is situated substantially at the two teeth (23.4, 23.5; 23′.4, 23′.5) immediately preceding the first specialized tooth (23.3; 23′.3) for upward gearshifting.

18. Pair of toothed wheels according to claim 15, wherein the inner beveling (45; 45′) of the first specialized tooth (23.3; 23′.3) for upward gearshifting is formed by a lowered zone (45; 45′) with respect to the plane of the inner side (19) of the wheel, extending between a crest (24; 24′) of the tooth (23.3; 23′.3) and a chord (28) near to the base of the tooth (23.3; 23′.3), for the entire width of the tooth (23.3; 23′.3).

19. Pair of toothed wheels according to claim 18, wherein the lowered zone (45; 45′) is defined by an oblique surface that approaches the middle plane of the wheel (11) going in the normal direction of rotation (R) corresponding to pedaling forward.

20. Pair of toothed wheels according to claim 14, wherein the wheel (11) of greater diameter, at the first specialized tooth (23.3; 23′.3) for upward gearshifting, comprises, on the outer side (18), a side projection (30, 30a; 30b; 130), projecting with respect to an outer plane (25) of the wheel (11).

21. Pair of toothed wheels according to claim 14, wherein the first specialized tooth (23.3; 23′.3) for upward gearshifting comprises, on the outer side (18) of the wheel (11), an apical beveling (50) at the crest (24; 24′) of the tooth (23.3; 23′.3).

22. Pair of toothed wheels according to claim 14, wherein the wheel (11) of greater diameter comprises at least one second specialized tooth (23.4; 23′.4) for upward gearshifting situated immediately in front of said first specialized tooth (23.3; 23′.3) for upward gearshifting with respect to a normal direction of rotation (R) corresponding to pedaling forward, wherein the second specialized tooth (23.4; 23′.4) for upward gearshifting comprises—on the outer side (18) of the wheel (11) and at the base of the tooth (23.4; 23′.4)—a first outer beveling (40; 40′), formed by an oblique surface that approaches a middle plane of the wheel (11) going in the opposite direction to the normal direction of rotation (R).

23. Pair of toothed wheels according to claim 22, wherein the second specialized tooth (23.4; 23′.4) for upward gearshifting comprises—on the outer side (18) of the wheel (11) and at a crest (24; 24′) of the tooth (23.4; 23′.4)—a second outer beveling (42), formed by an oblique surface that approaches the middle plane of the wheel (11) going in the normal direction of rotation (R).

24. Pair of toothed wheels according to claim 22, wherein the second specialized tooth (23.4; 23′.4) for upward gearshifting comprises, on the inner side (19) of the wheel, an apical beveling (51) at a crest (24; 24′) of the tooth (23.4; 23′.4).

25. Pair of toothed wheels according to claim 22, wherein the wheel (11) of greater diameter comprises at least one third specialized tooth (23.5; 23′.5) for upward gearshifting situated immediately in front of said second specialized tooth (23.4; 23′.4) for upward gearshifting with respect to the normal direction of rotation (R), wherein the third specialized tooth (23.5; 23′.5) for upward gearshifting comprises—on the outer side (18) of the wheel (11) and at the base of the tooth (23.5; 23′.5)—a first outer beveling (41; 41′), formed by an oblique surface that approaches the middle plane of the wheel (11) going in the opposite direction to the normal direction of rotation (R), the first outer beveling (41; 41′) of the third specialized tooth (23.5; 23′.5) for upward gearshifting having less extension than the first outer beveling (40; 40′) of the second specialized tooth (23.4; 23′.4) for upward gearshifting.

26. Pair of toothed wheels according to claim 25, wherein the third specialized tooth (23.5; 23′.5) for upward gearshifting comprises—on the outer side (18) of the wheel (11) and at a crest (24; 24′) of the tooth (23.5; 23′.5)—a second outer beveling (43; 43′), formed by an oblique surface that approaches the middle plane of the wheel (11) going in the normal direction of rotation (R).

27. Pair of toothed wheels according to claim 25, wherein the third specialized tooth (23.5; 23′.5) for upward gearshifting comprises, on the inner side (19) of the wheel (11), an apical beveling (52) at a crest (24; 24′) of the tooth (23.5; 23′.5).

28. Pair of toothed wheels according to claim 14, wherein the wheel (11) of greater diameter comprises at least one fourth specialized tooth (23.2; 23′.2) for upward gearshifting situated immediately behind said first specialized tooth (23.3; 23′.3) for upward gearshifting with respect to a normal direction of rotation (R) corresponding to pedaling forward, wherein the fourth specialized tooth (23.2; 23′.2) for upward gearshifting comprises—on the inner side (19) of the wheel (11)—an inner beveling (47; 47′) formed by a lowered zone with respect to the inner side (19) of the wheel (11) near such a fourth specialized tooth (23.2; 23′.2).

29. Pair of toothed wheels according to claim 28, wherein the wheel (11) of greater diameter, at the fourth specialized tooth (23.2; 23′.2) for upward gearshifting, comprises, on the outer side (18), a side projection (30, 30a; 30b; 130), projecting with respect to an outer plane (25) of the wheel (11).

30. Pair of toothed wheels according to claim 28, wherein the fourth specialized tooth (23.2; 23′.2) for upward gearshifting comprises, on the outer side (18) of the wheel (11), an apical beveling (49) at a crest (24; 24′) of the tooth (23.2; 23′.2).

31. Pair of toothed wheels according to claim 28, wherein the wheel (11) of greater diameter comprises at least one fifth specialized tooth (23.1; 23′.1) for upward gearshifting situated immediately behind said fourth specialized tooth (23.2; 23′.2) for upward gearshifting with respect to the normal direction of rotation (R), wherein the fifth specialized tooth (23.1; 23′.1) for upward gearshifting comprises—on the inner side (19) of the wheel—an inner beveling (46; 46′) formed by a lowered zone with respect to an inner plane (26) of the wheel (11) near such a fifth specialized tooth (23.1; 23′.1).

32. Pair of toothed wheels according to claim 31, wherein the wheel (11) of greater diameter, at the fifth specialized tooth (23.1; 23′.1) for upward gearshifting, comprises, on the outer side (18), a side projection (30, 30a; 30b; 130), projecting with respect to an outer plane (25) of the wheel (11).

33. Pair of toothed wheels according to claim 31, wherein the fifth specialized tooth (23.1; 23′.1) for upward gearshifting comprises, on the outer side (18) of the wheel (11), an apical beveling (48) at a crest (24; 24′) of the tooth (23.1; 23′.1).

34. Pair of toothed wheels according to claim 31, wherein the inner bevelings (45-47; 45′-47′) of the first (23.3; 23′.3), of the fourth (23.2; 23′.2), and of the fifth specialized tooth (23.1; 23′.1) for upward gearshifting are the same, each defined by an oblique surface that approaches a middle plane of the wheel (11) going in the normal direction of rotation (R).

35. Pair of toothed wheels according to claim 31, wherein the inner bevelings (45-47; 45′-47′) of the first (23.3; 23′.3), of the fourth (23.2; 23′.2), and of the fifth specialized tooth (23.1; 23′. 1) for upward gearshifting each have a different depth to the others with respect to a middle plane of the wheel (11).

36. Pair of toothed wheels according to claim 35, wherein the inner bevelings (45-47; 45′-47′) of the first (23.3; 23′.3), of the fourth (23.2; 23′.2), and of the fifth specialized tooth (23.1; 23′.1) for upward gearshifting each have a smaller depth than the previous one with respect to the middle plane of the wheel (11).

37. Pair of toothed wheels according to claim 31, wherein the wheel (11) of greater diameter, at the fourth (23.2; 23′.2) and at the fifth specialized tooth (23.1; 23′.1) for upward gearshifting, comprises, on the outer side (18), respective identical side projections (30, 30a; 30b; 130), projecting with respect to an outer plane (25) of the wheel (11).

38. Pair of toothed wheels according to claim 37, wherein the wheel (11) of greater diameter, at the first specialized tooth (23.3) for upward gearshifting, comprises, on the outer side (18), a side projection (30a), projecting with respect to the outer plane (25) of the wheel (11), such a projection (30a) having a smaller extension in the radial direction with respect to the projection (30) at the fourth (23.2) and fifth specialized tooth (23.1) for upward gearshifting.

39. Pair of toothed wheels according to claim 37, wherein the wheel (11) of greater diameter, at the first specialized tooth (23′.3) for upward gearshifting, comprises, on the outer side (18), a side projection (30b), projecting with respect to the outer plane (25) of the wheel (11), such a projection (30b) having a greater extension in the radial direction with respect to the projection (30) at the fourth (23′.2) and fifth specialized tooth (23′.1) for upward gearshifting, up to a crest (24′) of the tooth (11).

40. Pair of toothed wheels according to claim 14, wherein the wheel (11) of smaller diameter has an inner side (19) facing towards the wheel (11) of greater diameter and an outer side (18) opposite the inner side (19) and comprises at least one first specialized tooth (23.3; 23′.3) for upward gearshifting, and wherein such a tooth (23.3; 23′.3) comprises, on the outer side (18), a side projection (30, 30a; 30b; 130), projecting with respect to an outer plane (25) of the wheel (11).

41. Sprocket assembly of a bicycle drivetrain, comprising at least one toothed wheel (11) according to claim 1.

42. Sprocket assembly of a bicycle drivetrain, comprising at least one pair of toothed wheels (11) according to claim 14.

43. Crankset of a bicycle drivetrain, comprising at least one toothed wheel (11) according to claim 1.

44. Crankset of a bicycle drivetrain, comprising at least one pair of toothed wheels (11) according to claim 14.

45. Gearshift group of a bicycle drivetrain, comprising at least one toothed wheel (11) according to claim 1.

46. Gearshift group of a bicycle drivetrain, comprising at least one pair of toothed wheels (11) according to claim 14.

47. Bicycle drivetrain, comprising at least one toothed wheel (11) according to claim 1.

48. Bicycle drivetrain, comprising at least one pair of toothed wheels (11) according to claim 14.

49. A toothed wheel of a bicycle drivetrain comprising:
two opposite sides (18, 19);
a central portion (16); and
a peripheral portion (17) surrounding said central portion, said peripheral portion (17) comprising
a plurality of teeth (23; 23′) configured for engagement with a chain (K) of the bicycle drivetrain, and
at least one side projection (30, 30a; 30b; 130) extending from at least one of said teeth (23; 23′), said at least one side projection (30, 30a; 30b; 130) defining a through opening (33),
wherein said at least one projection (30, 30a; 30b) is formed by stamping, coining, or embossing together with said opening (33).

50. A toothed wheel of a bicycle drivetrain comprising:
a central portion (16); and
a peripheral portion (17) surrounding said central portion, said peripheral portion (17) comprising
a plurality of teeth (23; 23′) configured for engagement with a chain (K) of the bicycle drivetrain, and
at least one side projection (30, 30a; 30b; 130) extending from at least one of said teeth (23; 23′),
wherein said at least one projection (30, 30a; 30b) is formed by stamping, coining, or embossing.

51. A toothed wheel of a bicycle drivetrain comprising:
two opposite sides (18, 19);
a central portion (16); and
a peripheral portion (17) surrounding said central portion, said peripheral portion (17) comprising
a plurality of teeth (23; 23′) configured for engagement with a chain (K) of the bicycle drivetrain, and
at least one side projection (30, 30a; 30b; 130) extending from at least one of said teeth (23; 23′) and formed through displacement of material of the peripheral portion (17) of the toothed wheel (11).

52. The toothed wheel according to claim 51, wherein the displacement of material is obtained by stamping, coining, or embossing.

53. A toothed wheel of a bicycle drivetrain comprising:
two opposite sides (18, 19);
a central portion (16); and
a peripheral portion (17) surrounding said central portion, said peripheral portion (17) comprising
a plurality of teeth (23; 23′) configured for engagement with a chain (K) of the bicycle drivetrain, and
at least one side projection (30, 30a; 30b; 130) extending from at least one of said teeth (23; 23′), said at least one side projection (30, 30a; 30b; 130) defining a through opening (33).

54. The toothed wheel according to claim 53, wherein the through opening is a circular cylindrical hole (33), having its axis parallel to the axis of the toothed wheel (11).

55. A pair of toothed wheels of a group of toothed wheels of a bicycle drivetrain, said pair of toothed wheels comprising:
a wheel (11) of greater diameter and a wheel (11) of smaller diameter having a flat shape between two opposite sides (18, 19), each of said wheels (11) comprising
a central portion (16), and
a peripheral portion (17) surrounding said central portion (16), said peripheral portion (17) comprising a plurality of teeth (23; 23′) configured for engagement with a chain (K) of the bicycle drivetrain,
said wheel (11) of greater diameter further comprising
an outer side (18) facing towards said wheel (11) of smaller diameter,
an inner side (19) opposite said outer side (18),
a first specialized tooth (23.3; 23′.3) for upward gearshifting, wherein said outer side (18) of said peripheral portion (17) of said toothed wheel (11) of greater diameter comprises a substantially flat area (20; 20′) without recesses, situated in front with respect to said first tooth (23.3; 23′.3) and outside of said teeth (23; 23′),
at least one fourth specialized tooth (23.2; 23′.2) for upward gearshifting situated immediately behind said first specialized tooth (23.3; 23′.3) for upward gearshifting with respect to a normal direction of rotation (R) corresponding to pedaling forward, wherein said fourth specialized tooth (23.2; 23′.2) for upward gearshifting comprises—on said inner side (19) of said wheel (11)—an inner beveling (47; 47′) formed by a lowered zone with respect to said inner side (19) of said wheel (11) near such a fourth specialized tooth (23.2; 23′.2), and
at least one fifth specialized tooth (23.1; 23′.1) for upward gearshifting situated immediately behind said fourth specialized tooth (23.2; 23′.2) for upward gearshifting with respect to said normal direction of rotation (R), wherein said fifth specialized tooth (23.1; 23′.1) for upward gearshifting comprises—on said inner side (19) of said wheel—an inner beveling (46; 46′) formed by a lowered zone with respect to an inner plane (26) of said wheel (11) near such a fifth specialized tooth (23.1; 23′.1),
wherein the wheel (11) of greater diameter, at said fourth (23.2; 23′.2) and at said fifth specialized tooth (23.1; 23′.1) for upward gearshifting, comprises, on said outer side (18), respective identical side projections (30, 30a; 30b; 130), projecting with respect to an outer plane (25) of said wheel (11).

56. A pair of toothed wheels of a group of toothed wheels of a bicycle drivetrain, said pair of toothed wheels comprising:
a wheel (11) of greater diameter and a wheel (11) of smaller diameter having a flat shape between two opposite sides (18, 19), each of said wheels (11) comprising
a central portion (16), and
a peripheral portion (17) surrounding said central portion (16), said peripheral portion (17) comprising a plurality of teeth (23; 23′) configured for engagement with a chain (K) of the bicycle drivetrain,
said wheel (11) of greater diameter further comprising
an outer side (18) facing towards said wheel (11) of smaller diameter,
an inner side (19) opposite said outer side (18),
at least one fourth specialized tooth (23.2; 23′.2) for upward gearshifting with respect to a normal direction of rotation (R) corresponding to pedaling forward, and
at least one fifth specialized tooth (23.1; 23′.1) for upward gearshifting situated immediately behind said fourth specialized tooth (23.2; 23′.2) for upward gearshifting with respect to said normal direction of rotation (R),
wherein the wheel (11) of greater diameter, at said fourth (23.2; 23′.2) and at said fifth specialized tooth (23.1; 23′.1) for upward gearshifting, comprises, on said outer side (18), respective identical side projections (30, 30a; 30b; 130), projecting with respect to an outer plane (25) of said wheel (11).

57. A pair of toothed wheels of a group of toothed wheels of a bicycle drivetrain, said pair of toothed wheels comprising:
a wheel (11) of greater diameter and a wheel (11) of smaller diameter having a flat shape between two opposite sides (18, 19), each of said wheels (11) comprising
a central portion (16), and
a peripheral portion (17) surrounding said central portion (16), said peripheral portion (17) comprising a plurality of teeth (23; 23′) configured for engagement with a chain (K) of the bicycle drivetrain,
said wheel (11) of greater diameter further comprising
an outer side (18) facing towards said wheel (11) of smaller diameter,
an inner side (19) opposite said outer side (18), and
a first specialized tooth (23.3; 23′.3) for upward gearshifting, wherein said outer side (18) of said peripheral portion (17) of said toothed wheel (11) of greater diameter comprises a substantially flat area (20; 20′) without recesses, situated in front with respect to said first tooth (23.3; 23′.3) and outside of said teeth (23; 23′),
wherein said inner side (19) of said peripheral portion (17) of said toothed wheel (11) of greater diameter comprises a substantially flat area (50; 50′) without recesses around said first tooth (23; 23′).

58. A pair of toothed wheels of a group of toothed wheels of a bicycle drivetrain, said pair of toothed wheels comprising:
a wheel (11) of greater diameter and a wheel (11) of smaller diameter having a flat shape between two opposite sides (18, 19), each of said wheels (11) comprising
a central portion (16), and
a peripheral portion (17) surrounding said central portion (16), said peripheral portion (17) comprising a plurality of teeth (23; 23′) configured for engagement with a chain (K) of the bicycle drivetrain,
said wheel (11) of greater diameter further comprising
an outer side (18) facing towards said wheel (11) of smaller diameter,
an inner side (19) opposite said outer side (18),
a first specialized tooth (23.3; 23′.3) for upward gearshifting, wherein said outer side (18) of said peripheral portion (17) of said toothed wheel (11) of greater diameter comprises a substantially flat area (20; 20′) without recesses, situated in front with respect to said first tooth (23.3; 23′.3) and outside of said teeth (23; 23′),
wherein said substantially flat area (20) without recesses is situated substantially at said two teeth (23.4, 23.5; 23′.4, 23′.5) immediately preceding said first specialized tooth (23.3; 23′.3) for upward gearshifting.

59. A pair of toothed wheels of a group of toothed wheels of a bicycle drivetrain, said pair of toothed wheels comprising:
a wheel (11) of greater diameter and a wheel (11) of smaller diameter having a flat shape between two opposite sides (18, 19), each of said wheels (11) comprising
a central portion (16), and
a peripheral portion (17) surrounding said central portion (16), said peripheral portion (17) comprising a plurality of teeth (23; 23′) configured for engagement with a chain (K) of the bicycle drivetrain,
said wheel (11) of greater diameter further comprising
an outer side (18) facing towards said wheel (11) of smaller diameter,
an inner side (19) opposite said outer side (18),
a first specialized tooth (23.3; 23′.3) for upward gearshifting, wherein said outer side (18) of said peripheral portion (17) of said toothed wheel (11) of greater diameter comprises a substantially flat area (20; 20′) without recesses, situated in front with respect to said first tooth (23.3; 23′.3) and outside of said teeth (23; 23′),
wherein said wheel (11) of greater diameter comprises at least one second specialized tooth (23.4; 23′.4) for upward gearshifting situated immediately in front of said first specialized tooth (23.3; 23′.3) for upward gearshifting with respect to a normal direction of rotation (R) corresponding to pedaling forward, wherein said second specialized tooth (23.4; 23′.4) for upward gearshifting comprises—on said outer side (18) of said wheel (11) and at the base of said tooth (23.4; 23′.4)—a first outer beveling (40; 40′), formed by an oblique surface that approaches a middle plane of said wheel (11) going in the opposite direction to said normal direction of rotation (R).

60. The pair of toothed wheels according to claim 59, wherein said wheel (11) of greater diameter comprises at least one third specialized tooth (23.5; 23′.5) for upward gearshifting situated immediately in front of said second specialized tooth (23.4; 23′.4) for upward gearshifting with respect to said normal direction of rotation (R), wherein said third specialized tooth (23.5; 23′.5) for upward gearshifting comprises—on said outer side (18) of said wheel (11) and at the base of said tooth (23.5; 23′.5)—a first outer beveling (41; 41′), formed by an oblique surface that approaches said middle plane of said wheel (11) going in the opposite direction to said normal direction of rotation (R), said first outer beveling (41; 41′) of said third specialized tooth (23.5; 23′.5) for upward gearshifting having less extension than said first outer beveling (40; 40′) of said second specialized tooth (23.4; 23′.4) for upward gearshifting.

61. A bicycle drive train gear comprising:
a disk having opposite sides (18, 19) that define generally parallel surfaces and a plurality of peripherally spaced teeth that define a maximum diameter for said gear; and
at least one of said teeth has a projection that extends beyond one of said parallel surfaces and is positioned to guide a bicycle chain between said gear and another gear of the drive train.

62. The bicycle drive train gear according to claim 61, further comprising a through opening (33) at said projection (30, 30a; 30b).

63. The bicycle drive train gear according to claim 62, wherein said projection (30, 30a; 30b) is obtained by stamping, coining, or embossing together with said opening (33).

64. A bicycle drive train gear comprising:
a disk having opposite sides (18, 19) that define generally parallel surfaces and a plurality of teeth that define a maximum diameter for said gear; and
at least one projection that is positioned on a selected tooth to guide a bicycle chain between said gear and another gear of the drive train and extends beyond one of said parallel surfaces.

65. The bicycle drive train gear according to claim 64, further comprising a through opening (33) at said at least one projection (30, 30a; 30b).

66. The bicycle drive train gear according to claim 65, wherein said at least one projection (30, 30a; 30b) is obtained by stamping, coining, or embossing together with said opening (33).
